(19) United States
(12) Patent Application Publication
(10) Pub. No.: US 2011/0180198 A1
(43) Pub. Date: Jul. 28, 2011

(54) CONDUCTIVE PASTE AND A METHOD FOR PRODUCING ELECTRONIC COMPONENT

(76) Inventors: Sanshiro AMAN, Tokyo (JP); Satoshi Takagi, Tokyo (JP); Yuki Kamada, Tokyo (JP)

(21) Appl. No.: 13/006,200

(22) Filed: Jan. 13, 2011

(30) Foreign Application Priority Data
Jan. 25, 2010 (JP) 2010-013383

(51) Int. Cl. C04B 35/64; H01B 1/00

(52) U.S. Cl. 156/89.12; 252/518.1; 252/520.21

(57) ABSTRACT

A purpose of the present invention is to provide a conductive paste which is capable to prevent the structural defect and to provide a method for producing electronic components including an internal electrode layer formed by the conductive paste.

A conductive paste comprises metallic particles, solvent, rein, a first inhibitor, a second inhibitor and a third inhibitor, wherein sintering start temperatures of the first inhibitor, the second inhibitor and the third inhibitor are higher than a sintering start temperature of the metallic particles, when an average particle size of the first inhibitor is defined as “a”, an average particle size of the second inhibitor is defined as “b”, an average particle size of the third inhibitor is defined as “c”, “a”, “b” and “c” fulfill a predetermined relation.

### BACKGROUND OF THE INVENTION

1. Field of the Invention

The present invention relates to a conductive paste and a method for producing electronic component having an internal electrode layer formed by the conductive paste.

2. Description of the Related Art

As one example of electric component equipped to electronic device, a multilayer type ceramic component is exemplified, a capacitor, a band filter, inductor, a multilayer type three-terminal filter, a piezoelectric element, PTC thermistor, NTC thermistor or a varistor and the like are known.

A capacitor element body to compose these multilayer type ceramic electronic components is produced by, for example, preparing a rectangular solid shape green chip composed by laminating a green sheet which becomes a dielectric layer after firing and an internal electrode pattern layer which becomes an internal electrode layer after firing, and co-firing thereof. In recent years, there is high requirement to densification of respective components according to downsizing for electronic components, accordingly a laminating number of dielectric layer tends to be increased.

However, there is a problem that an occurrence ratio of structural defect of the multilayer type ceramic electronic components becomes higher, due to increasing laminating number of a dielectric layer for the multilayer type ceramic electronic components.

From the above actual circumstances, it has been required that a technology which is capable to prevent the structural defect, even though a laminating number of the dielectric layer of the multilayer type ceramic components is increased.

For example, in Patent Document 1 (Japanese Patent Laid Open No. 2001-110233), it is disclosed that structural defect and decreasing capacitance of the multilayer type electronic components which have a conductive paste whose main component is nickel powder can be prevented by adding one kind of inhibitor which is identical with a dielectric layer to a conductive paste which becomes a internal electrode after firing.

However, it is difficult to effectively prevent misalignment of a timing of shrinking of the green sheet and a timing of the internal electrode pattern layer by adding one kind of the inhibitor.

### SUMMARY OF THE INVENTION

The present invention has been made by considering the actual circumstances, and a purpose is to provide a conductive paste which is capable to prevent the structural defect and electronic components and to provide a method for producing electronic components including an internal electrode layer formed by the conductive paste.

As a result of intentional study by the present inventors for a phenomenon of occurrence the structural deficiency to the electronic components, they found following problems to achieve the completion of the present invention.

Initially, the present inventors firstly have found the structural deficiency of the electronic components is originated by misalignment between sintering start temperature of a dielectric raw material included in a green sheet and sintering start temperature of metallic particles included in an internal electrode pattern layer. Specific mechanism is as follows. Namely, although the volume of the green sheet and the internal electrode pattern layer shrink by firing, the sintering start temperature of internal electrode pattern layer is lower than that of the green sheet. Therefore, a misalignment between a timing of shrinking start of the green sheet and a timing of shrinking start of the internal electrode pattern layer is occurred. Also, an active force by the misalignment of the timing of shrinking start tends to be applied to a vertical direction of respective layers of the electronic components, namely to a laminating direction, which brings crack occurred to a horizontal direction of each layer of the electronic components.

Secondary, the present inventors have found that the timing of shrinking start of the internal electrode pattern layer tends to become faster by increasing laminating number of the dielectric layer, thereby the misalignment of the shrinking start between the green sheet and the internal electrode pattern layer which causes to increase crack occurrence rate further.

The present inventors have found the structural defect occurred when increasing the laminating number of the electronic components is due to the above mentioned mechanism so that they achieved to complete the present invention.

### SUMMARY OF THE INVENTION

Namely, a conductive paste according to the present invention comprises

metallic particles, solvent, rein, a first inhibitor, a second inhibitor and a third inhibitor, wherein

sintering start temperatures of the first inhibitor, the second inhibitor and the third inhibitor are higher than a sintering start temperature of the metallic particles,

when an average particle size of the first inhibitor is defined as “a”, an average particle size of the second inhibitor is defined as “b”, an average particle size of the third inhibitor is defined as “c”,

“a”, “b” and “c” fulfill following relations

a/b=0.8 to 1.2 (1)

a,b<c (2).

Because the conductive paste according to an embodiment of the present invention comprises a plurality of the above mentioned specific inhibitors, sintering at an internal electrode pattern layer occurs at high temperature side and the sintering starts stepwise and dispersed, compared with a case not comprising the inhibitors. Therefore, the timing of shrinking start of the internal electrode patter layer becomes slow, a shrinking speed becomes slow too. Therefore, by using the conductive paste according to the present embodiment, the structural defect occurred from the misalignment between the timing of shrinking start of the green sheet and the timing of shrinking start of the internal electrode pattern layer, specifically, cracking can be prevented.

Preferably, a sintering start temperature of a material of the second inhibitor is higher than a sintering start temperature of a material of the first inhibitor.

Preferably, a sintering start temperature of a material of the third inhibitor is higher than the sintering start temperature of the material of the first inhibitor and is lower than the sintering start temperature of the material of the second inhibitor.

Preferably, a content of the second inhibitor in the conductive paste is 40 to 65 parts by weight with respect to 100 parts by weight of the first inhibitor and a content of the third inhibitor in the conductive paste is 12.5 to 22.5 parts by weight with respect to 100 parts by weight of the first inhibitor.

Preferably, a proportion of total weight of the first inhibitor, the second inhibitor and the third inhibitor is 25 to 45 wt % to a weight of the metallic particles.

Preferably, the material of the first inhibitor contains ATiO₃,

a material of the second inhibitor contains BZrO₃,

the A and the B are at least any one kind of Ba, Ca, Sr.

Also, a producing method of electronic components according to the present invention comprises steps of

obtaining a green chip by cutting after laminating a green sheet composed of a ceramic paste, an internal electrode pattern layer composed of the above mentioned conductive paste, and

firing the green chip.

Preferably, the first inhibitor is composed of the same kind of material as a main component of the ceramic paste used for forming dielectric layer of electronic components,

the second inhibitor and the third inhibitor are composed of the same kind of material as a sub-component of the ceramic paste.

Preferably, the material of the second inhibitor is different from the material of the third inhibitor.

Preferably, the firing process comprises a first firing process and a second firing process.

Preferably, a holding temperature of the second firing process is 10 to 30° C. higher than a holding temperature of the first firing process.

Preferably, a hydrogen concentration in the firing process is 3% or less.

As for electronic components according to the embodiment of the present invention, although it is not particularly limited, a multilayer type electronic components, specifically, a multilayer ceramic capacitor, a piezoelectric element, a tip inductor, a tip varistor, a tip thermistor, a tip resistor and other surface-mounted devices (SMD) tip type electronic components are exemplified.

According to the present invention, a conductive paste which is capable to prevent a structural defect of the electronic components and a producing method for the electronic components comprising an internal electrode layer formed from the conductive paste thereof, even though a laminating number of the dielectric layer is increased.

### BRIEF DESCRIPTION OF THE DRAWINGS

FIG. 1 is a cross sectional view of a multilayer ceramic capacitor according to one embodiment of the present invention.

FIG. 2(a) is an explanation drawing of sintering start temperature, FIG. 2(b) is an enlarged view of a IIB section of the explanation drawing of FIG. 2(a).

FIG. 3(a) to FIG. 3(c) are schematic views showing dispersing conditions of metallic particles, a first inhibitor, a second inhibitor, a third inhibitor in the conductive paste according to embodiments of the present invention.

FIG. 4a is a process schematic view showing a producing step of multilayer ceramic capacitor shown in FIG. 1.

FIG. 4b is a process schematic view showing continuous step of FIG. 4a.

FIG. 4c is a process schematic view showing continuous step of FIG. 4b.

FIG. 5(a) is a graph showing a relation of shrinking rate and temperature to a time at a firing step of a method for producing electronic components according to examples and comparative examples of the present invention, FIG. 5(b) is an enlarged graph of VB section of FIG. 5(a).

### DESCRIPTION OF THE PREFERRED EMBODIMENTS

Below, the present invention will be explained on the basis of embodiments shown in the drawings.

### Multilayer Capacitor 1

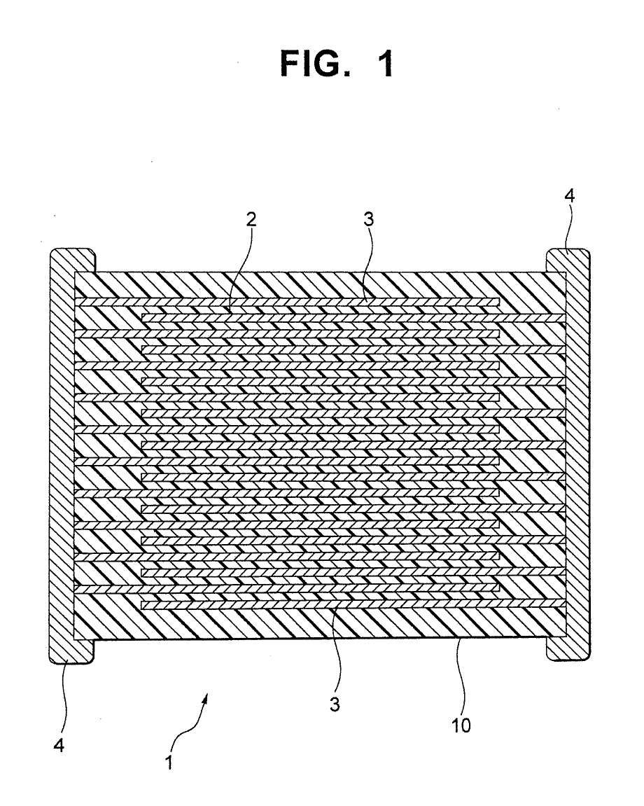

As shown in FIG. 1, a multilayer ceramic capacitor 1 according to one embodiment of the present invention comprises a capacitor element body 10 configured by alternately laminated dielectric layers 2 and internal electrode layers 3. End portions on both sides of the capacitor element body 10 are formed with a pair of external electrodes 4 respectively conducting to the internal electrode layers 3 arranged alternately in the capacitor element body 10.

The internal electrode layers 3 are laminated, so that the respective end surfaces are exposed alternately to surfaces of two facing end portions of the capacitor element body 10. Also the pair of the external electrode 4 is formed on both end portions of the capacitor element body 10 and connected to the exposed end surfaces of the alternately arranged internal electrode layers 3, so that a capacitor circuit is configured.

### (Dielectric Layer 2)

The dielectric layers 2 according to the present embodiment are obtained by firing a green sheet. Regarding components included in the dielectric layers 2, it will be specified later.

### (Internal Electrode Layer 3)

The internal electrode layers 3 according to the present invention are obtained by firing the conductive paste. Also, the conductive paste is characterized by comprising metallic particles, solvent, resin, a first inhibitor, a second inhibitor and a third inhibitor.

### (External Electrode Layer 4)

Although a conductive material included in the external electrode layers 4 are not particularly limited, in normally, Cu, Cu alloy or Ni and Ni allow and the like are used. Note that of course Ag, Ag—Pd alloy and the like can be used too. Note that, in the present embodiment, inexpensive Ni, Cu and their alloys can be used.

### Producing Method for Multilayer Ceramic Capacitor

Next, a producing method for a multilayer ceramic capacitor 1 according to one embodiment of the present invention will be specified. In the present embodiment, a green chip is formed by normal printing method and sheet method using a paste, after firing thereof, a multilayer ceramic capacitor is produced by firing with printing or transferring an external electrode. Below, with respect to a producing method will be explained specifically.

### (Ceramic Paste)

Firstly, a dielectric raw material included in a ceramic paste is prepared to form coating, for preparing a ceramic paste. The ceramic paste may be an organic type coating wherein the dielectric raw material and an organic vehicle are kneaded or may be a water type coating.

Although composition of the dielectric raw material used for the multilayer ceramic capacitor according to the present invention is not particularly limited, it is preferable that a main component is ATiO₃ (A is at least any one kind of Ba, Ca, Sr), and a sub-component preferably includes BZrO₃ (B is at least any one kind of Ba, Ca, Sr).

Although as for other sub-components of the dielectric raw material used for multilayer ceramic capacitor of according to the present embodiment are not particularly limited, for example, oxide of Mg and oxide of R(R is at least one kind selected from Sc, Y, La, Ce, Pr, Nd, Pm, Sm, Eu, Gd, Tb, Dy, Ho, Er, Tm, Yb and Lu), oxide of at least one kind selected from Mn, Cr, Co and Fe, and oxide of at least one kind selected from Si, Li, Al, Ge and B may be included.

Content amount of the BZrO₃ is preferably 35 to 65 mol in terms of BZrO₃, more preferably 40 to 55 mol with respect to 100 mol of ATiO₃. By adding the BaZrO₃ in the above mentioned range, a capacitance-temperature characteristic and pressure resistance can be increased.

Content amount of the ATiO₃ is preferably 4 to 12 mol in terms of MgO, more preferably 6 to 10 mol with respect to 100 mol of ATiO₃. Oxide of Mg makes electrostriction smaller at the time of applying voltage, in addition to prevent the capacitance-temperature characteristic and pressure resistance reducing.

Content amount of R is preferably 4 to 15 mol in terms of R₂O₃, more preferably 6 to 12 mol with respect to 100 mol of ATiO₃. Oxide of the R performs to prevent decreasing the pressure resistance and to reduce the electrostriction at the time of applying voltage. Note that as for R element to compose the above mentioned oxide of the R, it is preferably at least one kind selected from Sc, Y, La, Ce, Pr, Nd, Pm, Sm, Eu, Gd, Tb, Dy, Ho, Er, Tm, Yb and Lu.

Content amount of the oxides of the Mn, Cr, Co and Fe is preferably 0.5 to 3 mol in terms of MnO, Cr₂O₃, CO₃O₄ or Fe₂O₃ with respect to 100 mol of AtiO₃. By adding these oxides in the above range, a lifetime characteristic, a specific permittivity and the capacitance-temperature characteristic can be made as excellent.

Content amount of the oxides of the Si, Li, Al, Ge and B is preferably 3 to 9 mol in terms of SiO₂, Li₂O₃, Al₂O₃, Ge₂O₂ or B₂O₃ to 100 mol of ATiO₃, more preferably 4 to 8 mol. By adding these oxides in the above range, a lifetime characteristic, a specific permittivity and the capacitance-temperature characteristic can be made as excellent.

By the dielectric raw material includes the above mentioned respective components as the above mentioned predetermined amount, firing of the green chip in a reduction atmosphere, and it is possible to reduce the electrostriction at the time of applying voltage, and to make excellent accelerated lifetime of the capacitance-temperature characteristic, specific permittivity, pressure resistance and insulation resistance. Specifically, deficiency caused by ATiO₃ which is included mainly as a base material, for example, a capacitance dependency to the applied voltage and electrostriction phenomenon at the time of applying voltage can be alleviated effectively. In addition, since the content amount of the BZrO₃ is caused as comparatively larger, it becomes capable to improve the capacitance-temperature characteristic and pressure resistance with maintaining the above mentioned characteristics as excellent.

Note that, in the present specification, although the respective oxide or compositional oxides to constitute the respective components are shown by stoichiometry, oxidation status of the respective oxides or compositional oxides may be out of the stoichiometry. However, the above mentioned proportional ratio of the respective components are calculated in terms of the oxides or compositional oxides of the above mentioned stoichiometry from metallic amount included in the oxides or compositional oxides which constitute the respective components.

Also, as for the dielectric raw material used for the multilayer ceramic capacitor according to the present embodiment, although the oxides, other mixtures and the compositional oxides of the above mentioned respective components, other various kinds of compound which become the above mentioned oxides and compositional oxides by firing, for example, it is suitably selected from carbonates, nitrates, hydrides, organic metallic compounds and the like and may be used by blending.

Also, in the raw materials of the respective composition, with respect to at least one part of the raw materials except for the ATiO₃, the respective oxides or compositional oxides, the components to be the respective oxides or compositional oxides by firing may be used as they are or may be used as roasting powder by pre-calcining.

The organic vehicle is obtained by dissolving a resin in organic solutions. The resin used for the organic vehicle is not particularly limited, it may be selected from ordinal various resins such as ethyl cellulose, polyvinyl butyral and the like. Also, the organic solutions used is not particularly limited too, it may be suitably selected from various organic solutions such as terpineol, butyl carbitol, acetone, toluene and the like, in response to methods to be utilized such as a printing method, sheet method and the like.

Also, in case that the ceramic paste is as a water type coating, a water type vehicle wherein water soluble resin, dispersing agent and the like are dissolved in water and the dielectric raw material may be kneaded. The water soluble resin used for the water type vehicle is not particularly limited, for example, polyvinyl alcohol, cellulose, water soluble acryl resin and the like may be used.

### (Conductive Paste)

A conductive paste according to the present embodiment comprises metallic particles, solvent, resin, a first inhibitor, a second inhibitor and a third inhibitor.

Although the metallic particles included in the conductive paste according to the present embodiment is not particularly limited, particles in which a main component is Ni or Ni alloy is preferable, more preferably, particles wherein Ni content amount is 90 wt % or more, further preferably particles wherein Ni content amount is 95 wt % or more is used. Note that, an average particle size of the metallic particles is preferably 0.1 μm to 0.7 μm.

As for the Ni alloy, an alloy composed of more than one kind of element selected from Mn, Cr, Co and Al, and Ni, and a percentage of Ni in the alloy is preferably 95 wt % or more. Note that, in the Ni or Ni alloy, various kind of minor components such as P and the like may be included about 0.1 wt % or less. As for the metallic particles, others are conductive material composed of alloy, or the above mentioned various oxides which becomes conductive material, organic metallic components, resinate and the like are exemplified.

The conductive paste according to the present embodiment has the most characteristic at a point of comprising the first inhibitor, the second inhibitor and the third inhibitor, in addition to the metallic particles, solvent and resin.

Sintering start temperatures of the first inhibitor, the second inhibitor and the third inhibitor included in the conductive paste according to the present embodiment are higher than a sintering start temperature of the metallic particle. As such, by comprising the inhibitors having high sintering start temperature compared with the conductive paste, each metallic particles contact are prevented, and a sintering start temperature of an internal electrode pattern layer shifts to higher temperature side. Then, by shifting the sintering start temperature to higher temperature, it is capable to prevent occurring crack of electronic components due to the misalignment between the timing of shrinking start of the green sheet and the timing of shrinking start of the internal electrode pattern layer.

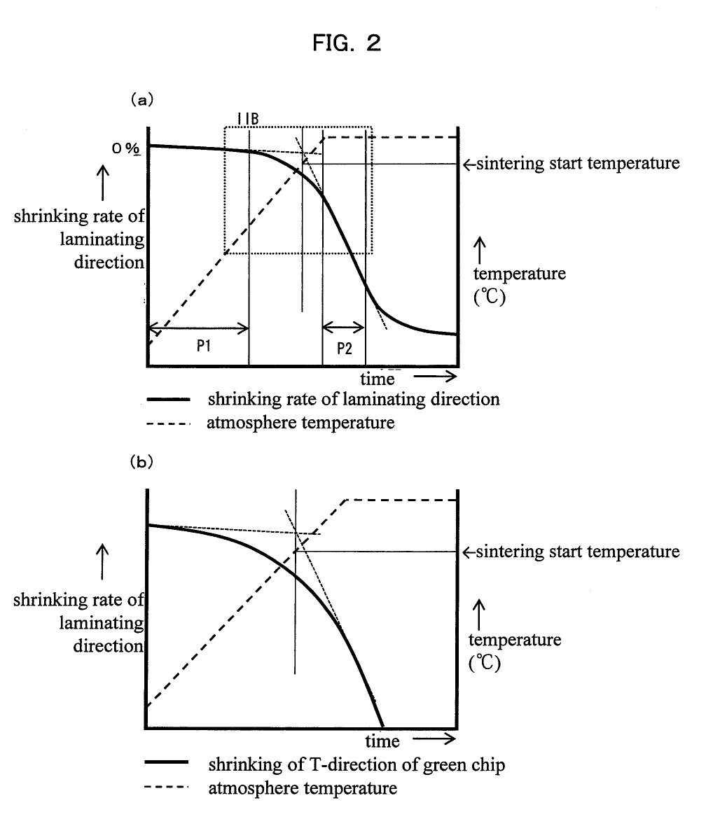

Note that, the sintering start temperature is calculated from vertical direction of each layer, namely alteration of shrinking rate of laminating direction. As mentioned above, because the internal pattern layer are shrunk by the sintering, this is due to the alteration becomes a barometer of the sintering start. Explanatory drawings are shown in FIG. 2(a) and FIG. 2(b).

At first, a shrinking rate (C_{α}) at an arbitral temperature α is calculated from a following formula (3).

$$shrink rate ( C α ) [ \% ] = \frac{height of laminating direction at an arbitral temperatue α}{height of laminating direction immediately before firing process} \times 100 - 100 [ \% ]$$

(3)

Note that, in the formula (I), the height of laminating direction immediately before firing process means a height of laminating direction immediately after binder removal process which is the height of laminating direction before changing the height of the laminating direction by the firing process.

In FIG. 2(a), an interval P1 is a zone wherein there is no change of a shrinking rate to a laminating direction, an interval P2 is a zone wherein the shrinking rate of the laminating direction descends. In the present invention, a temperature at an intersection point of a tangential line of intermediate P1 and a tangential line of P2 is defined as a sintering start temperature.

Also, by including the first inhibitor, the second inhibitor and the third inhibitor into the conductive paste, the sintering start of the internal electrode layer can be dispersed gradually. Thereby, the shrinking speed of the green sheet and that of the internal electrode pattern layer become gradually so that crack occurrence of the electronic components can be prevented effectively.

In the present embodiment, in case that an average particle size of the first inhibitor is defined as “a”, an average particle size of the second inhibitor is defined as “b” and an average particle size of the third inhibitor is defined as “c”, it is characterized to fulfill following relational expressions (1) and (2).

a/b=0.8 to 1.2 (1)

a,b<c (2)

Generally, the sintering start temperatures tend to higher, when the average particles of the inhibitors are larger. As described above, the sintering start temperatures can be dispersed stepwise by modifying the average particle sizes of the first inhibitor, the second inhibitor and the third inhibitor so that the crack of the electronic components can be prevented.

The a/b of the above mentioned formula (I) is preferably 0.85 to 1.15, more preferably 0.9 to 1.1. The a/b is either larger or smaller than the range, the crack occurrence rate tends to be increased.

Although the average particle size of the second inhibitor may be set suitably within the above range in response to a thickness of the internal electrode layer 3, preferably 0.05 to 0.4 μm, more preferably 0.05 to 0.2 μm.

Although the average particle size of the third inhibitor may be set suitably within the above range in response to a thickness of the internal electrode layer 3, preferably c/b is 1.1 to 2.3, more preferably 1.5 to 2.3.

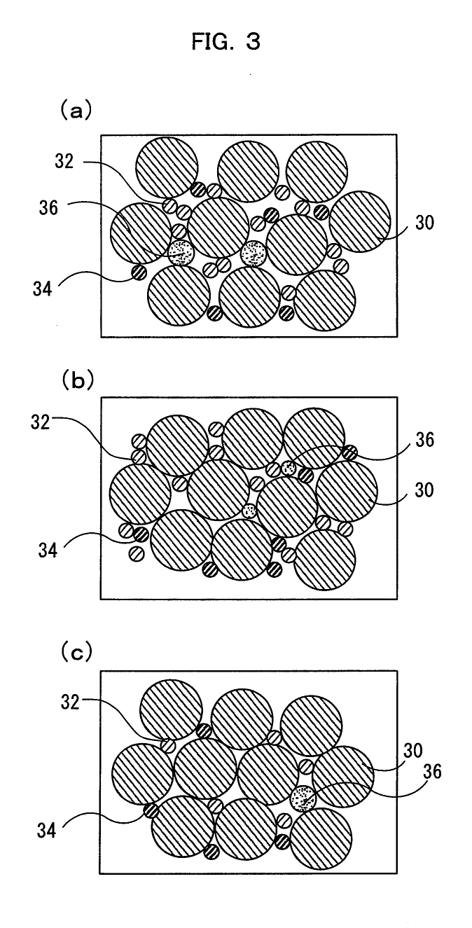

FIG. 3(a) is a schematic view showing dispersing condition of the metallic particles 30 and the respective inhibitors in the conductive paste, when the average particle sizes a, b and c fulfill the above mentioned relational expressions (1) and (2). Also, FIG. 3(b) is a schematic view showing dispersing condition of the metallic particles 30 and the respective inhibitors in the conductive paste, when the average particle size c of the third inhibitor is same level with the average particle sizes a and b.

As mentioned above, due to the contact of the metallic particles each other, the sintering tends to progress and the sintering start temperature tends to be lower and these cause cracking. Therefore, as shown in FIG. 3(a), it is considered when the average particle sizes of the first to third inhibitors are predetermined sizes, in particular, when the particle size of the third inhibitor 36 is larger than the particle sizes of the first inhibitor and the second inhibitor, the crack tend not to occur compared with FIG. 3(b).

In the present embodiment, preferably a sintering start temperature of a material of the second inhibitor is higher than a sintering start temperature of a material of the first inhibitor, more preferably, a sintering start temperature of a material of the third inhibitor is higher than the sintering start temperature of the material of the first inhibitor and is lower than the sintering start temperature of the material of the second inhibitor. Thereby, the sintering starts gradually so that the cracking can be prevented.

In the present embodiment, preferably a content of the second inhibitor in the conductive paste is 40 to 65 parts by weight, more preferably 40 to 60 parts by weight, further preferably 45 to 55 parts by weight with respect to 100 parts by weight of the first inhibitor, preferably a content of the third inhibitor in the conductive paste is 12.5 to 22.5 parts by weight, more preferably 14 to 21 parts by weight, further preferably 15 to 20 parts by weight with respect to 100 parts by weight of the first inhibitor. When the second inhibitor and the third inhibitor are within this range, the crack occurrence rate can be decreased.

In the present embodiment, a proportion of total weight of the first inhibitor, the second inhibitor and the third inhibitor to weight of the metallic particles is 25 to 40 wt % to the metallic particles, more preferably 28 to 45 wt %, further preferably 31 to 38 wt %. When the total weight of the first inhibitor, the second inhibitor and the third inhibitor is within the range, the crack occurrence rate can be decreased. Also, when the total weight of the inhibitors is larger than this range, a specific permittivity tends to be decreased.

Note that, FIG. 3(c) is a schematic view showing dispersing condition of the metallic particles 30 and the respective inhibitors in the conductive paste when the total weight of the inhibitors is small. As mentioned above, due to the contact of the metallic particles each other, the sintering progresses and the sintering temperature tends to be lower, these cause of cracking. Namely, it is considered, because the total weight of the inhibitors in FIG. 3(a) is larger than the total weight of the inhibitors in FIG. 3(c), the metallic particle tends not to contact each other, and thereby cracking can be prevented.

In the present embodiment, it is preferable that the first inhibitor is composed of the same kind of material as a main component of a ceramic paste, the second inhibitor and the third inhibitor are composed of the same kind of material as a sub-component of a ceramic paste. Also, more preferably, the first inhibitor is composed of ATiO₃, the second inhibitor is composed of BZrO₃, the second inhibitor is different from the third inhibitor, said “A” and “B” are at least one kind of Ba, Ca, Sr.

By making the inhibitors included in the conductive paste as such constitution, that a composition of components included in the internal electrode pattern layer and a composition of the components included in the green sheet become closer prevent dielectric raw material included in the internal electrode pattern layer from dispersing to the dielectric layer, it is capable to prevent deterioration of electric characteristic of the electronic components.

The above mentioned solvent and resin are included as vehicle. There is not limitation for content amounts of the solvent and resin, normal content amount, for example, the resin may be 1 to 5 wt % and the like, the solvent may be 10 to 50 wt % and the like.

The conductive paste is prepared by kneading the above mentioned metallic particles, the organic vehicle, the first inhibitor, the second inhibitor and the third inhibitor. Also, in the conductive paste, additive selected from various dispersing agent, plasticizing agent, dielectric body, insulation body and the like may be included in response to necessity. A total content amount is preferably 10 wt % or less.

### (Paste for External Electrode)

A paste for external electrode may be prepared as similar with the above mentioned the paste for internal electrode layer.

### Green Chip

When the printing method is used, the ceramic paste and the conductive paste are printed on a base plate made of as PET and the like, are laminated and are cutout as a predetermined shape, then, removed from the base plate so as to obtain a green chip. As for a process to obtain the green chip, specifically, following process is exemplified.

Also, when the sheet method is used, forming the green sheet by using the paste for derivative layer, and printing the internal electrode layer paste, then laminating thereof so as to be a green chip.

(Forming Green Sheet 10a)

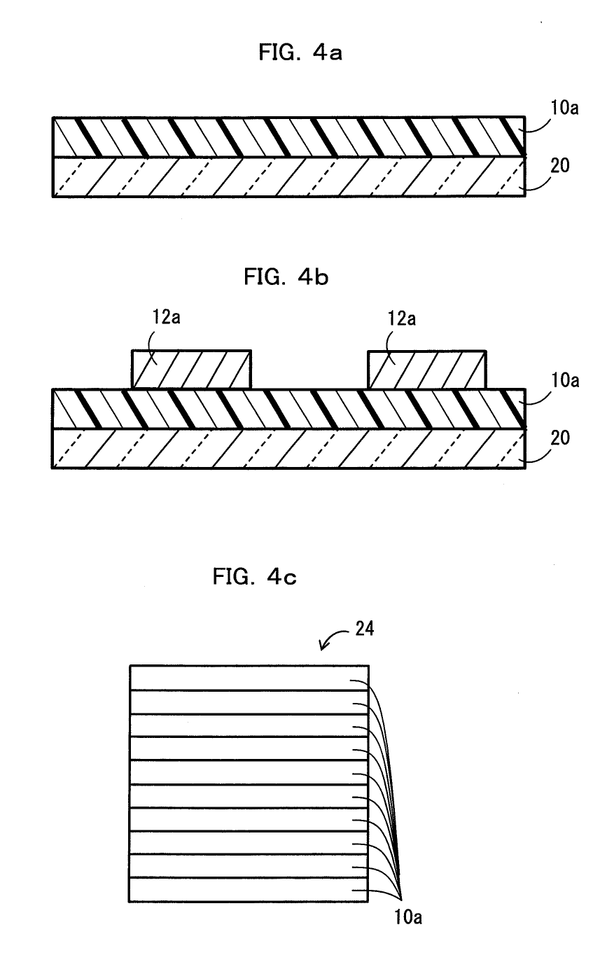

The ceramic paste produced via through the above mentioned process, as shown in FIG. 4a, is coated by, for example, doctor blade method and the like on a surface of a support sheet composed of, for example, PET film and the like so that a green sheet 10a is formed. The green sheet 10a becomes a dielectric layer 2 shown in FIG. 1, after fired.

(Forming Internal Electrode Layer 12a)

An internal electrode 3 of FIG. 1 can be obtained by firing an internal electrode pattern layer 12a shown in FIG. 4b. The internal electrode pattern 12a can be obtained by forming the conductive paste, which is produced through the above mentioned process, as a predetermined pattern shape.

Next, as shown in FIG. 4b, the conductive paste is coated as a predetermined pattern on a surface of the green sheet 10a formed on the support sheet 20a to form the internal electrode pattern layer 12a. The internal electrode pattern layer 12a becomes the internal electrode layer 3 shown in FIG. 1 after fired.

A method for forming the internal electrode pattern layer 12a of FIG. 4b is not particularly limited, it is capable to produce layers homogeneously, for example, a thick film forming method such as a screen printing method or a gravure printing method, or at thin film method such as deposition, sputtering and the like are exemplified.

As shown in FIG. 4c, the green sheet 10a wherein the internal electrode pattern layer 12a is formed is removed from the support sheet 20 so that a laminating body 24 is formed by laminating sequentially. The green sheet 10a is a portion which becomes the dielectric layer 2 shown in FIG. 1 and is alternately laminated with the internal electrode pattern layer 12a which becomes the internal electrode layer 3, then to be cutout as being the green chip.

Note that, a thickness of each dielectric layer 2 is normally 0.5 to 50 μm, as for a laminating number, in the present embodiment, it may be layered 20 to 300 layers. When the conductive paste according to the embodiment of the present invention is used, the sintering start temperature of the internal electrode pattern layer is dispersed gradually, and it shifts to high temperature side too, the crack occurred by the misalignment between the timing of shrinking start of the green sheet and the timing of shrinking start of the internal electrode pattern layer can be reduced. In normally, although the crack occurrence rate becomes higher due to the thinning of the dielectric layer and the increasing of the laminating number, in the present embodiment, the crack occurring rate can be prevented despite the thinning of the dielectric layer and the increasing of the laminating number by the above mentioned constitution.

### (Binder Removal Treatment)

Binder removal treatment is performed to the green chip, prior to firing. As for binder removal condition, a temperature rising speed is preferably 5 to 300° C./hr, a holding temperature is preferably 180 to 400° C. and a holding temperature time is preferably 0.5 to 24 hrs. Also, a firing atmosphere is preferably air or reducing atmosphere, as for an atmospheric gas in the reducing atmosphere is preferably, for example, a wet mixing gas of N₂ and H₂.

### (Firing Process)

As for a firing process according to the present embodiment, it is preferable to include a first firing step and a second firing step. A holding temperature of the second firing process is preferably 10 to 30° C. higher than a holding temperature of the first firing process, more preferably 15 to 28° C., further preferably 18 to 25° C. higher. When the difference of the holding temperatures of the first firing process and the second firing process is included within this range, the shrinking speed by firing, in particular the firing speed of high temperature atmosphere becomes slowly so that the cracking can be prevented.

Also, a holding temperature at firing is preferably 1000 to 1400° C., more preferably 1100 to 1360° C. When the holding temperature is within the range, density becomes sufficient, there is neither cutting the internal electrode due to abnormal sintering, nor deterioration of capacitance temperature characteristic due to dispersing the materials which compose the internal electrode pattern layer, and it is hard to reduce the dielectric layer.

Also, an atmosphere when firing the green chip according to the present embodiment is preferably 3% or less of hydrogen concentration, more preferably 1.5 to 0.2%, further preferably 0.7 to 0.2%. The shrinking of the internal electrode pattern layer stops when the maximum atmosphere temperature of the firing becomes max. At this time, due to including the hydrogen concentration within the range, the shrinking of the green sheet becomes slow. Thereby, a stress generated on the dielectric layer and the internal electrode layer is inhibited so that the crack can be prevented.

As for firing condition other than this, a temperature rising speed is preferably 50 to 500° C./hr, a temperature holding time is preferably 0.5 to 8 hr, a cooling time is preferably 50 to 500° C./hr.

### (Anneal)

The green chip becomes a capacitor element body 10 through the above mentioned process. In case the green chip is fired in the reducing atmosphere, it is preferable to conduct annealing to the capacitor element body 10. The annealing is the treatment for the reoxidation of the dielectric layer and thereby reliability is improved, because the IR lifetime can be increased considerably.

An oxygen partial pressure in the anneal atmosphere is preferably as 10⁻⁹ to 10⁻⁵ MPa. When the oxygen partial pressure is less than the above mentioned range, it is hard to treat reoxidation of the dielectric layer, and when excess the range, the internal electrode layer tends to be oxidized.

A holding temperature at the time of anneal is 1100° C. or less, particularly 500 to 1000° C. is preferable. By setting the holding temperature within the above range, oxidation of the dielectric layer becomes sufficient, high IR and IR lifetime can be increased easily.

As for other annealing condition, a temperature holding time is preferably 0 to 20 hrs, a cooling time is preferably 50 to 500° C./hr. Also, as for an atmosphere gas of the annealing, it is preferable to use, for example, a wet gas of N₂ gas and the like.

For a wet gas of N₂, a wet mixing gas and the like in the above mentioned binder removal treatment, sintering and annealing, for example, a wetter and the like can be used. In this case, a water temperature is preferably 5 to 75° C.

The binder removal treatment, sintering and annealing may be performed continuously or individually. When these are performed continuously, it is preferable that after binder removal treatment, an atmosphere is changed without cooling, subsequently to perform the firing with rising temperature until the holding temperature at the time of firing, then cooling, and performing the anneal with changing the atmosphere when the temperature is reached to the holding temperature. On the other hand, when these are performed individually, at the time of firing, after the temperature rises to the holding temperature when the binder removal treatment under N₂ gas or a wet gas of N₂ atmosphere, changing atmosphere and continuing the temperature rising which is preferable, the after cooling until the holding temperature at the time of annealing, again changing to N₂ gas or a wet gas of N₂ atmosphere and continue the cooling which is preferable. Also, at the time of annealing, the atmosphere may be changed after temperature rising until the holding temperature under N₂ gas atmosphere, also whole process of the annealing may be performed under the wet gas of N₂ gas atmosphere.

A tip end surface polishing, for example, by barrel polishing or sand blast, etc. is performed on the capacitor element body 10 obtained as above, and the external electrode paste is printed or transferred and sintered so that the external electrode 4 is formed. A firing condition of the external electrode paste is preferably, for example, at 600 to 800° C. in a wet mixing gas of N₂ and H₂ for 10 minutes to 1 hour or so. Then, in response to necessity, a coating layer is formed on the surface of the external electrode 4 by metal plating and the like.

A multilayer ceramic capacitor produced by a producing method according to the present invention is mounted on a print substrate and the like by soldering and the like and is used for variety of electronic apparatuses and the like.

Note that, the present invention is not limited to the above mentioned embodiment, and can be modified within a scope of the present invention. For example, the present invention is not limited to the multilayer ceramic capacitor, and may be used for any electronic components having a dielectric layer and an internal electrode layer, specifically, inductors, varistor and the like are exemplified.

### EXAMPLES

Below, although the present invention will be specified based on precise examples, the present invention is not limited to these examples.

### Samples 1 to 12

### (Ceramic Paste)

Initially, as for a main component of dielectric material included in a ceramic paste, BaTiO₃ was prepared. Also, as for the sub-component of the dielectric material, 43 parts by mol of BaZrO₃, 9 parts by mol of MgCO₃, 12 parts by mol of Gd₂O₃, 2.5 parts by mol of MnCO₃ and 4.5 parts by mol of SiO₂ to 100 parts by mol of BaTiO₃ were prepared.

Next, the sub-components except for the BaZrO₃ were blended by a ball-mill and an obtained mixture powder was preliminarily calcined so that a roasted powder was prepared. Next, BaTiO₃ as a main component, BaZrO₃ as sub-component and the roasted powder were wet pulverized by the ball-mill during 15 hrs and dried so that the dielectric material was obtained. Note that, the MgCO₃ was included in the dielectric material as MgO after firing. Below, components of the above mentioned sub-components of the dielectric material except for the BaZrO₃ are caused as additive materials.

Next, 100 parts by weight of the obtained dielectric material, 10 parts by weight of polyvinyl butyral resin, 5 parts by weight of dibutyl phthalate as a plasticizer (DOP) and 100 parts by weight of alcohol as solvent were blended by a ball-mill for pasting so that a ceramic paste was obtained.

### (Conductive Paste)

As separated from the above, 44.6 parts by weight of Ni particulate, 52 parts by weight of terpineol, 3 parts by weight of ethyl cellulose, 0.4 parts by weight of benzotriazole were prepared, and further 20 parts by weight of BatiO₂ as first inhibitor, 10 parts by weight of BaZrO₃ as second inhibitor, 3.4 parts by weight of roasted powder of additives composed of the above mentioned MgCO₃, Gd₂O₃, MnCO₃ and SiO₂ as third inhibitor to 100 parts by weight of the Ni particulate where kneaded by three roller for making slurry so that a conductive paste was produced. Note that, average particle sizes of the first inhibitor, second inhibitor and third inhibitor in the samples 1 to 12 are as shown in Table 1.

Then, a green sheet was formed on a PET film by using the ceramic paste produced as above so that its thickness after drying becomes 30 μm. Next, after printing electrode layers by a predetermined pattern thereon by using the conductive paste, a sheet was peeled-off from the PET film so that the green sheet having internal electrode pattern layer was produced. Then, the green sheet having internal electrode pattern layer was laminated to 200 layers so as to make a multilayer body by pressure binding, and a green chip was obtained by cut out the multilayer body to a predetermined size.

Next, with respect to the obtained green chip, binder removal treatment, firing and annealing were performed under following mentioned condition so that a capacitor element body 10 was obtained.

The binder removal treatment condition was set as temperature rising speed: 25° C./hr, holding time: 260° C., temperature holding time: 8 hrs, atmosphere: air.

The firing condition was set as temperature rising speed: 200° C./hr, holding temperature as first firing process: 1250° C., holding time; after firing 1 hr, holding temperature as second firing process: 1260° C., holding time: firing 1 hr, cooling time: cooled at 200° C./hr. During this, the atmosphere was set as a wet mixing gas of N₂+H₂ (hydrogen concentration 3%, oxygen partial pressure 10⁻¹² MPa).

The annealing condition was set as temperature rising speed: 200° C./hr, holding time: 1000 to 1100° C., temperature holding time: 2 hrs, cooling time: 200° C./hr, atmosphere gas: a wet gas of N₂ gas (oxygen partial pressure: 10 MPa). Note that, for humidifying the atmosphere gas at the time of firing and annealing, a wetter was used.

Next, after polishing an end face of the obtained multilayer ceramic firing body by sand blast, 1n-Ga was applied as an external electrode so as to obtain a sample of multilayer ceramic capacitor shown in FIG. 1. A size of the obtained capacitor sample was 3.2 mm×1.6 mm×3.2 mm, a thickness of the dielectric layer was 20 μm, a thickness of the internal electrode layer was 1.5 μm. Then, regarding samples 1 to 12, a crack occurrence rate after sintering was measured by a method as follows. Results are shown in Table 1.

### (Crack Occurrence Rate After Sintering)

A crack occurrence rate after sintering was calculated from a number of occurred cracking after sintering in the obtained 10000 pieces of capacitor element body 10. Results are shown in Table 1.

### Samples 13 to 24

In samples 13 to 24 of the present embodiment, except for changing kinds, average particle size and content weight ratio of the respective first inhibitor, second inhibitor and third inhibitor, a conductive paste was produced as similar with the samples 1 to 12, a plurality of capacitor samples having internal electrode layer where produced from these conductive paste, and the crack occurrence rate after sintering was measured. Conditions for the respective conductive paste and the crack occurrence rate after sintering are shown in Table 1.

### Samples 31 to 34

In samples 31 to 34 of the present embodiment, except for changing kinds, average particle size, content weight ratio and sintering start temperature of the respective first inhibitor, second inhibitor and third inhibitor, a conductive paste was produced as similar with the samples 1 to 12, a plurality of capacitor samples having internal electrode layer where produced from these conductive paste, and the crack occurrence rate after sintering was calculated. Conditions for the respective conductive paste and the crack occurrence rate after sintering are shown in Table 1.

Note that, the sintering start temperature for the inhibitors of the samples 31 to 34 are adjusted so as to be following relation.

For the sample 31, the sintering start temperature of the first inhibitor and the second inhibitor were adjusted by selecting ATiO₃ as the first inhibitor and by selecting BZrO₃ as the second inhibitor so that the sintering start temperature of the second inhibitor was higher than that of the second inhibitor, and the sintering start temperature of the second and the third inhibitors were adjusted by changing an amount of SiO₂ of MgCO₃, Gd₂O₃, MnCO₃ and SiO₂ included in the third inhibitor so that the sintering start temperature of the third inhibitor was higher than that of the second inhibitor.

For the sample 32, the sintering start temperature of the first inhibitor and the second inhibitor were adjusted by selecting ATiO₃ as the first inhibitor and by selecting BZrO₃ as the second inhibitor so that the sintering start temperature of the second inhibitor is higher than that of the second inhibitor, and the sintering start temperature of the third inhibitor was adjusted by changing an amount of SiO₂ of MgCO₃, Gd₂O₃, MnCO₃ and SiO₂ included in the third inhibitor so that the sintering start temperature of the third inhibitor is higher than that of the first inhibitor and was lower than that of the second inhibitor.

For the sample 33, the sintering start temperature of the first inhibitor and second inhibitor were adjusted by selecting ATiO₃ as the first inhibitor and by selecting BZrO₃ as the second inhibitor so that the sintering start temperature of the second inhibitor was higher than that of the second inhibitor, and the sintering start temperature of the third inhibitor was adjusted by changing an amount of SiO₂ of MgCO₃, Gd₂O₃, MnCO₃ and SiO₂ included in the third inhibitor so that the sintering start temperature of the third inhibitor was lower than that of the first inhibitor.

For the sample 34, kinds of material of the first inhibitor and the second inhibitor were selected so that the sintering starting temperature becomes lower than the first inhibitor.

Conditions for the respective conductive paste and the crack occurrence rate after sintering are shown in Table 2.

### Samples 41 to 50

In samples 41 to 50 of the present example, except for changing average particle size, content weight ratio of the respective first inhibitor, second inhibitor and third inhibitor, a conductive paste was produced as similar with the samples 1 to 12, a plurality of capacitor samples having internal electrode layer where produced from these conductive paste, and the crack occurrence rate after sintering was calculated. Conditions for the respective conductive paste and the crack occurrence rate after sintering are shown in Table 3.

### Samples 51 to 55

In samples 51 to 55 of the present example, except for changing average particle size, content weight ratio and total weight of the inhibitors of the respective first inhibitor, second inhibitor and third inhibitor, a conductive paste was produced as similar with the samples 1 to 12, capacitor samples having internal electrode layer where produced from these conductive paste, and the crack occurrence rate after sintering was calculated, further a difference of a shrinking rate of the dielectric layer and a shrinking rate of the inner electrode layer and a specific permittivity were measured too. Conditions for the respective conductive paste, the crack occurrence rate after sintering, the difference of the shrinking rate of the dielectric layer and the internal electrode layer, and the specific permittivity are shown in Table 4.

### (Difference of Shrinking Rate of Dielectric Layer and Shrinking Rate of Internal Electrode)

With respect to 50 pieces of the capacitor sample, the shrinking rate of the dielectric layer and the shrinking rate of the internal electrode layer were calculated respectively by following formulas (4) and (5) so that the difference of the shrinking rate of the dielectric layer and the shrinking rate of the internal electrode layer was measured and an average thereof were measured.

$$\begin{matrix} [ Formula 2 ] & \\ shrinking rate of dielectric layer [ \% ] = \frac{\begin{matrix}average height of laminating direction \\ after firing of 100 layers of dielectric layer\end{matrix}}{\begin{matrix}average height of laminating direction immediately \\ before firing of 100 layers of dielectric layer\end{matrix}} \times 100 - 100 [ \% ] & ( 4 ) \\ [ Formula 3 ] & \\ shrinking rate of internal electrode layer [ \% ] = \frac{\begin{matrix}average height of laminating direction after \\ firing of 100 layers of internal electrode layer\end{matrix}}{\begin{matrix}average height of laminating direction immediately \\ before firing of 100 layers of internal electrode layer\end{matrix}} \times 100 - 100 [ \% ] & ( 5 )\end{matrix}$$

### (Specific Permittivity ε)

Firstly, to the capacitor samples, under a reference temperature 25° C., a frequency 1 kHz under a digital LCR meter (4284A produced by YHP), a signal of an input signal level (measuring voltage) 1.0 Vrms was input so that a capacitance “C” was measured. Then, a specific permittivity ε (no unit) was calculated on the basis of a thickness of the dielectric layer, an effective electrode area and the capacitance “C” obtained as a result of the measuring. It is preferable that the specific permittivity is higher.

### Samples 61 to 65

In samples 61 to 65 of the present embodiment, except for changing holding temperatures of the first firing process and the second firing process under firing condition for a green chip, a conductive paste was produced as similar with the sample 2, a plurality of capacitor samples having internal electrode layer where produced from these conductive paste, and the crack occurrence rate after sintering was measured, further a crack occurrence rate in a thermal test and CR product were measured. Firing condition of the respective green chip and measuring results are shown in Table 5.

### (Crack Occurrence Rate in Thermal Test)

A crack occurrence rate in thermal test was calculated by that obtained 1000 pieces of capacitor element body were placed in an atmospheric temperature 360° C. during two seconds, and number of the elements to which crack was occurred.

### (CR Product)

To the capacitor samples, an insulation resistance IR was measured after applying a direct voltage of 5V/μm at 20° C. during one minute by using an insulation resistance meter (R8340A produced by Advantest). CR product was measured by calculating from a product of the capacitance “C” (unit is μF) measured in the above and the insulation resistance IR (unit is MΩ).

### Samples 71 to 73

In samples 71 to 73 of the present embodiment, except for changing hydrogen concentration of firing process under a firing condition of the green chip, a conductive paste was produced as similar with the sample 2, and a plurality of capacitor samples having internal electrode layer produced from these conductive paste. The crack occurrence rate after sintering, a difference of shrinking rate of the dielectric layer and shrinking rage of the internal electrode layer were measured. Firing condition of the respective green chip and measuring results are shown in Table 6.

TABLE 1

| | | | | | | | | content amount to 100 parts | | | |
|---|---|---|---|---|---|---|---|---|---|---|---|
| | average particle size | | | | | mateiral | | by weight of 1st inhibitor | | inhibitor | crack |
| | a | b | c | | | ATiO3 | BZᵣO3 | (parts by weight) | | total | occurrence |
| Sample | 1st | 2nd | 3rd | | a, | 1st | 2nd | 2nd | 3rd | weight | rate after |
| No. | inhibitor | inhibitor | inhibitor | a/b | b < c | inhibitor | inhibitor | inhibitor | inhibitor | (wt %) | sintering (ppm) |
| 1 | 0.07 | 0.1 | 0.2 | 0.7 | ∘ | BaTiO3 | BaZrO3 | 50 | 17.0 | 35.0 | 711 |
| 2 | 0.08 | 0.1 | 0.2 | 0.8 | ∘ | BaTiO3 | BaZrO3 | 50 | 17.0 | 35.0 | 202 |
| 3 | 0.1 | 0.1 | 0.2 | 1 | ∘ | BaTiO3 | BaZrO3 | 50 | 17.0 | 35.0 | 158 |
| 4 | 0.12 | 0.1 | 0.2 | 1.2 | ∘ | BaTiO3 | BaZrO3 | 50 | 17.0 | 35.0 | 197 |
| 5 | 0.13 | 0.1 | 0.2 | 1.3 | ∘ | BaTiO3 | BaZrO3 | 50 | 17.0 | 35.0 | 619 |
| 6 | 0.1 | 0.14 | 0.2 | 0.71 | ∘ | BaTiO3 | BaZrO3 | 50 | 17.0 | 35.0 | 826 |
| 7 | 0.1 | 0.12 | 0.2 | 0.83 | ∘ | BaTiO3 | BaZrO3 | 50 | 17.0 | 35.0 | 328 |
| 8 | 0.1 | 0.09 | 0.2 | 1.11 | ∘ | BaTiO3 | BaZrO3 | 50 | 17.0 | 35.0 | 248 |
| 9 | 0.1 | 0.08 | 0.2 | 1.25 | ∘ | BaTiO3 | BaZrO3 | 50 | 17.0 | 35.0 | 581 |
| 10 | 0.1 | 0.1 | 0.1 | 1.00 | x | BaTiO3 | BaZrO3 | 50 | 17.0 | 35.0 | 641 |
| 11 | 0.1 | 0.1 | 0.08 | 1.00 | x | BaTiO3 | BaZrO3 | 50 | 17.0 | 35.0 | 701 |
| 12 | 0.1 | 0.2 | 0.2 | 0.50 | x | BaTiO3 | BaZrO3 | 50 | 17.0 | 35.0 | 719 |
| 13 | 0.1 | 0.2 | — | 0.50 | x | BaTiO3 | BaZrO3 | 50 | 0.0 | 35.0 | 1093 |
| 14 | 0.3 | 0.1 | 0.2 | 3.00 | x | BaTiO3 | BaZrO3 | 50 | 17.0 | 35.0 | 658 |
| 15 | 0.1 | 0.1 | 0.2 | 1 | ∘ | CaTiO3 | BaZrO3 | 50 | 17.0 | 35.0 | 387 |
| 16 | 0.1 | 0.1 | 0.2 | 1 | ∘ | SrTiO3 | BaZrO3 | 50 | 17.0 | 35.0 | 341 |
| 17 | 0.1 | 0.1 | 0.2 | 1 | ∘ | BaTiO3 | CaZrO3 | 50 | 17.0 | 35.0 | 278 |
| 18 | 0.1 | 0.1 | 0.2 | 1 | ∘ | BaTiO3 | SrZrO3 | 50 | 17.0 | 35.0 | 369 |
| 19 | 0.1 | 0.1 | — | 1 | x | BaTiO3 | BaZrO3 | 50 | 0.0 | 35.0 | 1103 |
| 20 | 0.1 | — | 0.2 | — | Δ | BaTiO3 | — | 0 | 17.0 | 35.0 | 1073 |
| 21 | — | 0.1 | 0.2 | — | Δ | — | BaZrO3 | 50 | 17.0 | 35.0 | 1235 |
| 22 | 0.1 | — | — | — | x | BaTiO3 | — | 0 | 0.0 | 35.0 | 1587 |
| 23 | — | 0.1 | — | — | x | — | BaZrO3 | 50 | 0.0 | 35.0 | 1863 |
| 24 | — | — | 0.2 | — | x | — | — | 0 | 17.0 | 35.0 | 1781 |

TABLE 2

| | | | | | | high or low sintering | | content amount to 100 parts | | | |
|---|---|---|---|---|---|---|---|---|---|---|---|
| | average particle size | | | | | start temperature | | by weight of 1st inhibitor | | inhibitor | crack |
| | a | b | c | | | | 1st inhibitor < | (parts per weight) | | total | occurrence |
| Sample | 1st | 2nd | 3rd | | a, | 1st inhibitor < | 3rd inhibitor < | 2nd | 3rd | weight | rate after |
| No. | inhibitor | inhibitor | inhibitor | a/b | b < c | 2nd inhibitor | 2nd inhibitor | inhibitor | inhibitor | (wt %) | sintering (ppm) |
| 31 | 0.1 | 0.1 | 0.2 | 1 | ∘ | ∘ | x | 50 | 17.0 | 35.0 | 129 |
| 32 | 0.1 | 0.1 | 0.2 | 1 | ∘ | ∘ | ∘ | 50 | 17.0 | 35.0 | 67 |
| 33 | 0.1 | 0.1 | 0.2 | 1 | ∘ | ∘ | x | 50 | 17.0 | 35.0 | 158 |
| 34 | 0.1 | 0.1 | 0.2 | 1 | ∘ | x | x | 50 | 17.0 | 35.0 | 303 |

TABLE 3

| | | | | | | | | content amount to 100 parts | | | |
|---|---|---|---|---|---|---|---|---|---|---|---|
| | average particle size | | | | | material | | by weight of 1st inhibitor | | inhibitor | crack |
| | a | b | c | | | ATiO3 | BZrO3 | (parts by weight) | | total | occurrence |
| Sample | 1st | 2nd | 3rd | | a, | 1st | 2nd | 2nd | 3rd | weight | rate after |
| No. | inhibitor | inhibitor | inhibitor | a/b | b < c | inhibitor | inhibitor | inhibitor | inhibitor | (wt %) | sintering (ppm) |
| 41 | 0.1 | 0.1 | 0.2 | 1 | ∘ | BaTiO3 | BaZrO3 | 35 | 17.0 | 35.0 | 204 |
| 42 | 0.1 | 0.1 | 0.2 | 1 | ∘ | BaTiO3 | BaZrO3 | 40 | 17.0 | 35.0 | 167 |
| 43 | 0.1 | 0.1 | 0.2 | 1 | ∘ | BaTiO3 | BaZrO3 | 50 | 17.0 | 35.0 | 158 |
| 44 | 0.1 | 0.1 | 0.2 | 1 | ∘ | BaTiO3 | BaZrO3 | 65 | 17.0 | 35.0 | 182 |
| 45 | 0.1 | 0.1 | 0.2 | 1 | ∘ | BaTiO3 | BaZrO3 | 70 | 17.0 | 35.0 | 211 |
| 46 | 0.1 | 0.1 | — | 1 | ∘ | BaTiO3 | BaZrO3 | 50 | 0.0 | 35.0 | 1103 |
| 47 | 0.1 | 0.1 | 0.2 | 1 | ∘ | BaTiO3 | BaZrO3 | 50 | 12.0 | 35.0 | 290 |
| 48 | 0.1 | 0.1 | 0.2 | 1 | ∘ | BaTiO3 | BaZrO3 | 50 | 12.5 | 35.0 | 193 |
| 49 | 0.1 | 0.1 | 0.2 | 1 | ∘ | BaTiO3 | BaZrO3 | 50 | 22.5 | 35.0 | 178 |
| 50 | 0.1 | 0.1 | 0.2 | 1 | ∘ | BaTiO3 | BaZrO3 | 50 | 23.0 | 35.0 | 303 |

TABLE 4

| | | | | | | | | content amount to 100 parts | |
|---|---|---|---|---|---|---|---|---|---|
| | average particle size | | | | | material | | by weight of 1st inhibitor | |
| | a | b | c | | | ATiO3 | BZrO3 | (parts by weight) | |
| Sample | 1st | 2nd | 3rd | | a, | 1st | 2nd | 2nd | 3rd |
| No. | inhibitor | inhibitor | inhibitor | a/b | b < c | inhibitor | inhibitor | inhibitor | inhibitor |
| 51 | 0.1 | 0.1 | 0.2 | 1 | ∘ | BaTiO3 | BaZrO3 | 50 | 17.0 |
| 52 | 0.1 | 0.1 | 0.2 | 1 | ∘ | BaTiO3 | BaZrO3 | 50 | 17.0 |
| 53 | 0.1 | 0.1 | 0.2 | 1 | ∘ | BaTiO3 | BaZrO3 | 50 | 17.0 |
| 54 | 0.1 | 0.1 | 0.2 | 1 | ∘ | BaTiO3 | BaZrO3 | 80 | 17.0 |
| 55 | 0.1 | 0.1 | 0.2 | 1 | ∘ | BaTiO3 | BaZrO3 | 50 | 17.0 |

| | | difference of | | |
|---|---|---|---|---|
| | inhibitor | shrink rate of di- | | crack |
| | total | electric layer and | | occurrence |
| Sample | weight | shrink rate of | sepecific | rate after |
| No. | (wt %) | electrode layer | permittivity | sintering (ppm) |
| 51 | 24.0 | 1.70 | 324 | 208 |
| 52 | 25.0 | 1.56 | 317 | 181 |
| 53 | 35.0 | 1.51 | 308 | 158 |
| 54 | 45.0 | 1.45 | 305 | 145 |
| 55 | 46.0 | 1.39 | 285 | 101 |

TABLE 5

| | holding temperature | | | | | |
|---|---|---|---|---|---|---|
| | holding | holding | | | cruck | |
| | temperatuer of | temperatuer of | difference of | crack | occurrence | |
| | first firing | second firing | firing | occurrence | rate in | |
| Sample | process | process | temperature | rate after | thermal test | CR product |
| No. | T1(° C.) | T2(° C.) | T2 − T1(° C.) | sintering (ppm) | (ppm) | (MΩ · μF) |
| 61 | 1220 | 1260 | 40 | 135 | 252 | 2100 |
| 62 | 1230 | 1260 | 30 | 141 | 312 | 5200 |
| 63 | 1250 | 1260 | 10 | 138 | 467 | 6100 |
| 64 | 1255 | 1260 | 5 | 143 | 731 | 6800 |
| 65 | 1260 | 1260 | 0 | 158 | 754 | 7300 |

TABLE 6

| | hydrogen | difference of shrink | |
|---|---|---|---|
| | concentration of | rate of dielectric | crack occurrence |
| Sample | firing process | layer and shrink rate | rate after |
| No. | (%) | of electrode layer | sintering (ppm) |
| 11 | 3.5 | 1.51 | 158 |
| 72 | 3 | 1.43 | 102 |
| 73 | 0.5 | 1.38 | 78 |

From Table 1, it can be confirmed that the samples which include the first inhibitor, the second inhibitor and the third inhibitor at all (samples 1 to 12) become a result that lower crack occurrence rate, as compared from the samples which do not include at least one of the first inhibitor, the second inhibitor and the third inhibitor (samples 13, 19 to 24). It is considered that, when kinds of inhibitors are less, an effect for loosing shrinking speed of the internal electrode pattern layer by stepwise sintering cannot be exerted.

Also, from Table 1, when average particle sizes of the first inhibitor, the second inhibitor and the third inhibitor are set to satisfy relative formulas a/b=0.8 to 1.2 and a,b<c (a is an average particle size of the first inhibitor, b is an average particle size of the second inhibitor, c is an average particle size or the third inhibitor), it can be confirmed that the crack occurrence rate after sintering can be lowered (samples 2 to 4, 7, 8, 15 to 18). Contrary this, when the average particle sizes of the first inhibitor, the second inhibitor and the third inhibitor are set as out of the range, a result has been confirmed that the crack occurrence rate after sintering becomes higher (samples 1, 5, 6, 9 to 14, 19 to 24).

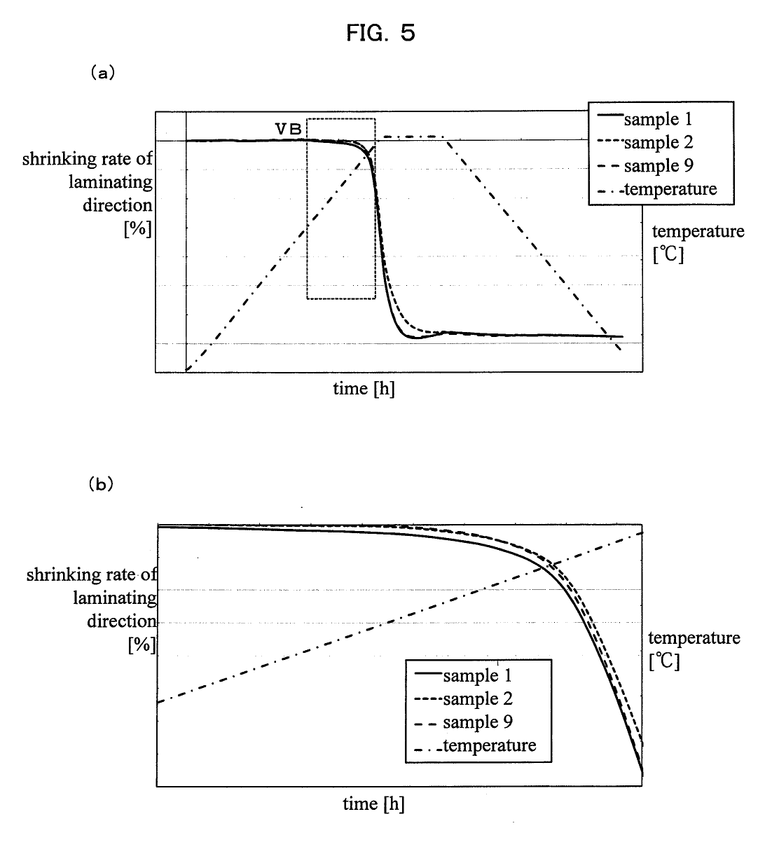

It is considered, as shown in FIG. 5(a) or FIG. 5(b), the crack occurrence rate after sintering of sample 1 and 9 becomes higher due to the sintering start temperature's shift to lower temperature side compared with sample 2, caused by that the average particle size of the first inhibitor of sample 1 was too small and the average particle size of the second inhibitor of sample 9 was too small.

Also, it can be considered that the crack occurrence rate after sintering of sample 5 and 6 becomes higher due to the sintering at once at higher temperature side caused by that the average particle size of the first inhibitor of sample 5 was too larger than that of the second inhibitor of sample 5 and the average particle size of the second inhibitor of sample 6 was too larger than that of the first inhibitor of sample 6.

Further, in the samples 10 and 11, it is considered that the crack occurrence rate becomes higher due to the sintering start temperature's shift to lower temperature side caused by that the third inhibitor having comparatively lower sintering start temperature become finer. Note that, dispersing conditions of metallic particles and the respective inhibitors in the conductive paste of the sample 10 is considered as corresponding to FIG. 3(b) of the schematic view.

From Table 2, in case that higher or lower correlations of the sintering starting temperature of the first inhibitor, the second inhibitor and the third inhibitor are that the first inhibitor<the second inhibitor and the first inhibitor<the third inhibitor<the second inhibitor (sample 32), it has been confirmed that the crack occurrence rate after sintering becomes excellent than in case it does not satisfy any one or both of the first inhibitor<the second inhibitor and the first inhibitor<the third inhibitor<the second inhibitor. Also, in case that any one or both the first inhibitor<the second inhibitor and the first inhibitor<the third inhibitor<the second inhibitor are not satisfied (samples 31, 33), it has been confirmed that the crack occurrence after sintering rate becomes excellent than in case that all of the first inhibitor<the second inhibitor and the first inhibitor<the third inhibitor<the second inhibitor are not satisfied (sample 34).

From Table 3, in case that a content of the second inhibitor in the conductive paste is including in 40 to 65 parts by weight with respect to 100 parts by weight of the first inhibitor and that a content of the third inhibitor in the conductive paste is included in 12.5 to 22.5 parts by weight with respect to 100 parts by weight of the first inhibitor (samples 42 to 44, 48, 49), it has been confirmed that the crack occurrence rate after sintering becomes lower than in case that out of the range (samples 41, 45 to 47, 50).

From Table 4, in case that a proportion of total weight of the inhibitors are included in 25 to 45 wt % to a weight of the metallic particles (samples 52 to 54), it has been confirmed that either difference of the shrinking rate of the dielectric layer and the shrinking rate of the internal electrode layer, the crack occurrence rate after sintering become excellent than in the case of out of the range.

From Table 5, it has been confirmed that, in case that a holding temperature of a second firing process is 10 to 30° C. higher than a holding temperature of a first firing process (samples 62, 63), either the crack occurrence rate in the thermal test and CR product become excellent than excluded in the range (sample 61, 64, 65). It has been considered due to that a shrinking speed of the internal electrode pattern layer becomes slowly by setting the firing process is set as two steps and an atmospheric temperature of the first firing process and the second firing process are set as narrow range of 10 to 30° C.

From Table 6, it has been confirmed that, in case that the hydrogen concentration in the firing process is 3% or less (samples 72, 73), either difference of the shrinking rate of the dielectric layer and the shrinking rate of the internal electrode layer, and the crack occurrence rate after sintering become more excellent than in case that the hydrogen concentration exceeds 3% (sample 71). It has been considered that, due to the hydrogen concentration is included in a predetermined range, shrinking of the green sheet becomes slower when the atmospheric temperature at the time of firing so that an acting force occurred in the dielectric layer and the internal electrode layer are prevented.

1. A conductive paste comprising;
metallic particles, solvent, rein, a first inhibitor, a second inhibitor and a third inhibitor, wherein
sintering start temperatures of the first inhibitor, the second inhibitor and the third inhibitor are higher than a sintering start temperature of the metallic particles,
when an average particle size of the first inhibitor is defined as “a”, an average particle size of the second inhibitor is defined as “b”, an average particle size of the third inhibitor is defined as “c”,
“a”, “b” and “c” fulfill following relations
a/b=0.8 to 1.2 (1)
a,b<c (2).

2. The conductive paste as set forth in claim 1, wherein
the sintering start temperature of a material of the second inhibitor is higher than the sintering start temperature of a material of the first inhibitor.

3. The conductive paste as set forth in claim 1, wherein
the sintering start temperature of a material of the third inhibitor is higher than the sintering start temperature of the material of the first inhibitor and is lower than the sintering start temperature of the material of the second inhibitor.

4. The conductive paste as set forth in claim 1, wherein
a content of the second inhibitor in the conductive paste is 40 to 65 parts by weight with respect to 100 parts by weight of the first inhibitor and
a content of the third inhibitor in the conductive paste is 12.5 to 22.5 parts by weight with respect to 100 parts by weight of the first inhibitor.

5. The conductive paste as set forth in claim 1, wherein
a proportion of total weight of the first inhibitor, the second inhibitor and the third inhibitor is 25 to 45 wt % to a weight of the metallic particles.

6. The conductive paste as set forth in claim 1, wherein
a material of the first inhibitor contains ATiO₃,
a material of the second inhibitor contains BZrO₃,
said “A” and said “B” are at least any one of Ba, Ca, Sr.

7. A producing method of electronic components comprising steps of;
obtaining a green chip by cutting after laminating a green sheet composed of a ceramic paste, an internal electrode pattern layer composed of the conductive paste as set forth in claim 1, and
firing the green chip.

8. The producing method of electronic components as set forth in claim 7, wherein
the first inhibitor is composed of the same kind of material as a main component of the ceramic paste used for forming dielectric layer of electronic components,
the second inhibitor and the third inhibitor are composed of the same kind of material as a sub-component of the ceramic paste.

9. The producing method of electronic components as set forth in claim 8, wherein
the material of the second inhibitor is different from the material of the third inhibitor.

10. The producing method of electronic components as set forth in claim 7, wherein
the firing process comprises a first firing process and a second firing process.

11. The producing method of electronic components as set forth in claim 10, wherein
a holding temperature of the second firing process is 10 to 30° C. higher than a holding temperature of the first firing process.

12. The producing method of electronic components as set forth in claim 7, wherein
a hydrogen concentration in the firing process is 3% or less.
